(19) United States
(12) Patent Application Publication
(10) Pub. No.: US 2026/0307954 A1
(43) Pub. Date: Oct. 8, 2026

(54) Free Fall Winch

(71) Applicant: Liebherr-Components Biberach GmbH, Biberach an der Riss (DE)

(72) Inventors: Norbert Hausladen, Biberach an der Riss (DE); Viktor Schindler, Uttenweiler (DE)

(21) Appl. No.: 19/493,092

(22) PCT Filed: May 15, 2024
(86) PCT No.: PCT/EP2024/063334

§ 371 Date: Dec. 12, 2025

(30) Foreign Application Priority Data
Jun. 14, 2023 (DE) 10 2023 115 442.7

(51) Int. Cl. B66D 1/22; B66D 5/18

(52) U.S. Cl. CPC B66D 1/22; B66D 5/18

(57) ABSTRACT

A free fall winch including a drum which can be rotated by a winch drive via a multistage planetary transmission. A drive stage of the planetary transmission is connected to the winch drive on an input side and can be braked by a service brake. An output stage of the planetary transmission is connected to the drum on an output side. A free fall brake is provided in order to brake the drum during a free fall operation and is connected to the planetary transmission by means of a brake rotor. The brake rotor of the free fall brake is rotationally fixed to a transmission element of the output stage or an optionally provided intermediate stage of the planetary transmission. At least the drive stage of the planetary transmission, including the sun gear, the planet carrier, and the ring gear thereof, are stopped during the free fall operation of the service brake.

### CROSS-REFERENCE TO RELATED APPLICATIONS

This application is a National Stage of International Application No. PCT/EP2024/063334 filed 15 Mar. 2024, which claims benefit under 35 USC § 365 of DE Application No. 10 2023 115 442.7 filed 14 Jun. 2023, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a free fall winch comprising a drum which can be rotated by a winch drive via a multistage planetary transmission, wherein a drive stage of the planetary transmission is connected to the winch drive on the input side and can be braked by a service brake and an output stage of the planetary transmission is connected to the drum on the output side, wherein a free fall brake is provided to brake the drum during a free fall operation and is connected to the planetary transmission by means of a brake rotor.

### 2. Description of Related Art

Free fall winches are used in various applications in which the cable wound on the drum of the winch or another pulling or lifting medium such as for example a belt is to be unwound or lowered at high speeds over longer distances, wherein the drum is rotating more or less without resistance at idle speed or possibly also under slight braking by the resistance of the transmission. Such unwinding is sometimes referred to as “free fall”. At least at the end of the free fall, it is necessary to relatively quickly slow down the cable drum in order to avoid further uncontrolled unwinding of the cable and thus slack cable on the winch drum and an untidy, confused cable image.

Such free fall winches can be used for example in cable excavators when a compacted mass is dropped to the ground in free fall for soil compaction. For this purpose, for example, individual planetary stages are decoupled in planetary transmissions used on drums so that the compaction load reaches the ground with the highest possible drop energy. Shortly before hitting the ground, however, the free fall brake must be slowed down so as not to create a slack rope on the winch drum. This process is repeated cyclically at short intervals, causing the cooling oil of the free fall brake and the friction coefficients of the brake bodies to change. Accordingly, the excavator operator must constantly readjust the braking of the free fall winch.

When working with a dragline, the same likewise is thrown into a quarry pond by rotating the uppercarriage of the cable excavator-similar to casting a fishing hook by means of a fishing rod-in order to extract gravel, for example. When the dragline hits the water surface, the drum previously activated must be slowed down in order to avoid a slack cable.

In the case of diaphragm wall grabs, by means of which very deep foundations are dug, the lowering of the grab is effected at a high, controlled falling speed, wherein here during lowering already the same must be controlled by slowing down the free-fall brake to control the falling speed. Here too, heating of the system and a change in the friction coefficients of the brake bodies mean that the braking force of the free fall brake must be readjusted in order to lower the cable with the gripper attached to it at the desired speed while maintaining a certain cable tension.

It is also desirable to be able to pull the cable off the free fall winch easily by hand for various handling tasks, for example to attach the cable to various pieces of equipment. Even when the free fall brake is open, frictional forces must be overcome in the interior of the winch, for example in the area of a transmission via which the winch drive drives the drum, and in the area of the free fall brake itself. Particularly with cold lubricant with a correspondingly high viscosity, this is hardly feasible by hand, so that support from the winch drive would be desirable, although the size of this drive support for manual removal depends on the temperature of the lubricant. While a stronger support is required with cold lubricant, a motorized pull-off support of the same strength with heated lubricant with only low viscosity can lead to an undesirably fast unwinding.

A free fall winch of the type mentioned at the beginning is shown, for example, in the document EP 0 538 662 B1, or also in DE 41 34 722 A1, in which the winch drive drives the drum via a two-stage planetary transmission, which is accommodated in the interior of the drum. A sun gear of one of the planetary stages can be driven by the winch drive and, on the other hand, blocked by a holding brake. A planet carrier of one of the planetary stages is guided out of the opposite end of the drum via a shaft, where it can be braked by a free fall brake that is supported on the bearing counter-shield.

By connecting the free fall brake to the planetary transmission, the gear ratio can be used to absorb a larger braking torque on the drum with a smaller braking torque on the free fall brake, so that a comparatively small free fall brake can be used and integrated into the drum interior. On the other hand, however, the rotating planetary stages of the planetary transmission during a free fall operation result in relatively large rotating inertial masses, which slow down the initial acceleration of the drum during a free fall operation and inhibit a quick start of the free fall. At the same time, when braking during a free fall operation, the advantage of the lower braking torque is partially impaired by the fact that the high inertial masses have to be braked, which requires a correspondingly high braking power and causes thermal loads.

A further free fall winch comprising a planetary transmission is shown in the document CN205151608 U, wherein relatively large rotating, inert masses must also be accelerated during a free fall operation by the rotating planetary stages of the planetary transmission.

Furthermore, there are also known free fall winches that operate with only one brake and simultaneously use the holding brake as a free fall brake. DE 3 223 632 C2, for example, shows a free fall brake whose drum is driven by a hydraulic motor via a two-stage planetary transmission, wherein the ring gear common to both planetary stages is connected to a brake shield to which the drum brake acting directly on the flanged pulley of the cable drum is attached. When the brake is applied, the torque is transmitted to the cable drum via the brake, thus achieving the connection between the motor and the cable drum, whereas when the brake is open, the planetary transmission is decoupled from the cable drum. However, the described cooling problem still exists with this brake arrangement. In addition, in order to hold the cable drum in load operation, for example when holding a lifted large load, high braking forces must be applied, which must be transmitted to the drum shell via the flanged pulley on which the brake acts.

Further free fall winches are also known from the documents EP 3678975B1 and WO 2019/048303 A1.

From the document DE 101 16 342 C2 there is known a Kelly winch in which the cable pull or an associated torque on the drum is monitored when the cable is unwound. For this purpose, the winch drive is basically rotatably mounted on the drum, but supported on the frame via a lever-shaped torque support, wherein a measuring device detects the load on the torque support in order to determine the supported torque. Depending on the load detected on the torque support, the winch drive is controlled in such a manner that the load on the torque support does not fall below a certain level, thus maintaining an associated torque on the drum and correspondingly a residual tensile force on the cable in order to prevent slack cable.

Furthermore, the document DE 10 2014 109 918 A1 shows a drilling device whose drilling tool can be lowered along a mast by a winch. A hydraulic pump driving the winch is controlled as a function of a cable pull force, which is measured by means of a force measuring pin on a deflection pulley of the cable.

Proceeding therefrom, it is the underlying problem of the present invention to create an improved free fall winch of a type mentioned at the beginning, which avoids the disadvantages of the prior art and further develops the latter in an advantageous manner. In particular, an improved dynamic free fall and braking operation is to be achieved, which facilitates smooth, fast acceleration and braking during a free fall operation and requires a free fall brake of small dimensions without overheating or suffering thermal performance losses.

### BRIEF SUMMARY OF THE INVENTION

The problem is achieved by a free fall winch comprising a drum which can be rotated by a winch drive via a multistage planetary transmission, wherein a drive stage of the planetary transmission is connected to the winch drive on the input side and can be braked by a service brake, and an output stage of the planetary transmission is connected to the drum on the output side, wherein a free fall brake is provided to brake the drum during a free fall operation and is connected to the planetary transmission by means of a brake rotor, wherein the brake rotor of the free fall brake is rotationally fixed to a transmission element of the output stage or an optionally provided intermediate stage of the planetary transmission, wherein at least the drive stage of the planetary transmission including the sun gear, the planet carrier and the ring gear thereof are stopped during the free fall operation of the service brake.

It is therefore proposed to connect the brake rotor of the free fall brake to the planetary transmission, but not to the first planetary stage or the drive stage thereof, which would result in favorable conditions with regard to the braking torque, but at the same time would impair the winch dynamics during a free fall operation due to the high inertial masses, as all planetary stages would also rotate during a free fall operation. In order to, on the one hand, utilize the gear ratio of the planetary transmission for the free fall brake and to have a certain reduction of the braking torque at the free fall brake, but on the other hand to reduce the inertial masses during a free fall operation, it is proposed to connect the free fall brake not to the drive stage of the planetary transmission, but to a downstream planetary stage.

According to the invention, the brake rotor of the free fall brake is rotationally fixed to a transmission element of the output stage or an optionally provided intermediate stage of the planetary transmission, wherein at least the drive stage of the planetary transmission, including its sun gear, planet carrier and ring gear, can be stopped by means of the service brake during a free fall operation. By stopping at least the entire first planetary stage, i.e., the drive stage of the planetary transmission connected to the winch drive, the rotating inertial masses can be significantly reduced during a free fall operation, since the transmission elements of the first planetary stage, i.e., its sun gear, its planet carrier, its planet gears and its ring gear, do not rotate when the drum rotates during a free fall operation and the rotation of the drum is only transmitted to the brake rotor of the free fall brake via a part of the planetary transmission. By stopping the otherwise fast-rotating planetary stage during free fall operation, the inertial masses to be accelerated for free fall operation can be reduced considerably, as the fast-rotating transmission elements have a greater influence on inertia.

Since the inertial masses are known to change quadratically with the transmission ratio, namely according to the relationship J₂=J₁×i², in which i indicates the transmission ratio and J the moment of inertia, a considerable reduction in the mass moment of inertia can be achieved, which in turn reduces the load on the free fall brake and results in a lower thermal load. Above all, however, a significantly more dynamic free fall operation can be achieved. On the one hand, the drum can accelerate much faster when the free-fall process is initiated, as at least one planetary stage, which is at a standstill, does not need to be accelerated as well. Due to the faster acceleration at the start of free fall operation, the dragline, for example, can be ejected further when used in the dragline area, because the inertial masses in the drum are lower. Similarly, more energy can be used for soil compaction at the same drop height of the mass and also in the case of diaphragm wall grabs, where chiseling is carried out from low drop heights to loosen hard rock, the grab receives more energy when it hits the rock at the same drop height. Conversely, the drum can also be braked again very quickly at the end of the free fall process, as the free fall brake only has to slow down a reduced inertial mass, which means that a relatively small free fall brake is sufficient without suffering thermal overloads.

In a further development of the invention, the planetary transmission can be configured with at least three stages, wherein the brake rotor of the free fall brake can be connected to an intermediate planetary stage, which is provided between the drive stage and the output stage of the planetary transmission in relation to the force flow or torque flow in winch operation. This allows a favorable compromise to be achieved between, on the one hand, as few rotating gear parts as possible with correspondingly reduced inertial masses and, on the other hand, a limitation of the braking torque required at the free fall brake. If the brake rotor of the cable drum were connected directly to the drum in order to brake the drum directly in relation to the winch position, a maximum reduction of the inertial masses and thus a very dynamic free fall operation could be achieved. On the other hand, however, such a constellation would require very high braking torques on the free fall brake, as this would have to apply the drum braking torque without a transmission ratio.

If the planetary transmission has four or more stages, the brake rotor of the free fall brake can be connected to the intermediate stage of the planetary transmission or coupled in a rotationally fixed manner, which forms the second planetary stage of the planetary transmission or connects directly to the drive stage of the planetary transmission. This can still achieve a fairly strong reduction in the braking torque occurring at the free fall brake, while conversely an entire planetary stage can still be shut down and eliminated with regard to its inertial masses for free fall operation.

In an alternative further development of the invention, however, it would also be possible to connect the brake rotor of the free fall brake to a third planetary stage, i.e., an intermediate stage which is not directly coupled to the first planetary stage or the drive stage of the planetary transmission, but is coupled to the drive stage via at least one further intermediate stage. This could achieve an even greater reduction in the inertial masses, while on the other hand a less pronounced but still given reduction in the braking torque can be achieved.

If the free fall brake is not connected to the second planetary stage but to a further intermediate stage, for example the third planetary stage, the planetary transmission can advantageously be configured to be connectable in such a way that not only the drive stage but also the second planetary stage including its sun gear, planet carrier and ring gear can be stopped for free fall operation in order to achieve an even greater reduction in the inertial masses. In this case, the rotation of the drum during a free fall operation is transmitted past the first and second planetary stages only via the output stage and the remaining at least one further intermediate stage to the brake rotor of the free fall winch. For example, such switchability can have a clutch and/or a brake for engagement with a transmission element of the second and/or third planetary stage in order to be able to stop the second planetary stage-in addition to the drive stage-when the drum rotates during a free fall operation and the third and possibly each further planetary stage transmits the rotation of the drum to the brake rotor.

Even if the planetary transmission can have four or even more planetary stages, it is advantageous to use a three-stage planetary transmission and in this case to connect the brake rotor of the free fall brake to the intermediate stage, i.e., the second planetary stage. With a three-stage planetary transmission, a compact design can be achieved with a sufficient transmission ratio and, by connecting the brake rotor to the intermediate stage, an overall quite small inertial mass can be achieved during a free fall operation, resulting in agile, dynamic free fall behavior.

In order to be able to stop the first planetary stage, i.e., the drive stage of the planetary transmission during the free fall operation in a simple manner with only a few shiftable transmission elements, it can be provided in an advantageous further development of the invention that the drive stage has a transmission element, which, in addition to the transmission element which can be stopped by the service brake, is supported in a fixed position or can be stopped by a further brake, so that during the free fall operation, on the one hand, one transmission element of the drive stage is stopped by the service brake and a further transmission element of the drive stage is also immobilized by its rotationally fixed support or support blocked by a brake.

If, for example, the winch drive is connected to the sun gear of the drive stage of the planetary transmission, the ring gear of the drive stage can be supported, for example, in a rotationally fixed manner on the bearing block of the cable winch or another stationary installation environment component, so that the ring gear is also stationary during winch operation. If the sun gear is then braked or stopped by the service brake during a free fall operation, the complete first planetary stage and, in addition, the transmission element of the second planetary stage, which is connected in a rotationally fixed manner to the output element of the drive stage, are stationary. In the exemplary embodiment with brakable sun gear and ring gear supported in a rotationally fixed manner on the bearing block, the output element of the first planetary stage would be its planet carrier, which would then also be stationary when the sun gear is braked and can, for example, be coupled to the sun gear of the second planetary stage, so that in this case the sun gear of the second planetary stage is also stationary during a free fall operation and contributes to the further reduction of the inertial masses.

Alternatively, it would also be possible to connect another transmission element of the first planetary stage, for example its ring gear or planet carrier, to the winch drive instead of the sun gear and to support a second transmission element of the drive stage stationarily or in a rotationally fixed manner, for example the sun gear or the planet carrier, in order to be able to stop again the entire first planetary stage during a free fall operation by locking the service brake.

In order to achieve an overall compact design and in particular also to be able to arrange the free fall brake at least partially in the interior of the drum, it can be provided in an advantageous further development of the invention that the output stage of the planetary transmission is arranged between the drive stage and an intermediate stage of the planetary transmission when viewed in the axial direction. In particular, the drive stage and the at least one intermediate stage can be arranged at opposite axial end portions of the planetary transmission, while the output stage coupled to the drum is arranged in an axial middle portion of the planetary transmission.

This makes it easy to connect the winch drive and/or arrange the service brake on one axial end face of the planetary transmission, while the free fall brake can be arranged on the opposite axial end face of the planetary transmission. In particular, the brake rotor of the free fall brake can be easily connected to the intermediate stage of the planetary transmission arranged on the end face, for example to the ring gear of the intermediate stage, which can form the end face of the planetary transmission.

The free fall brake can advantageously be arranged completely in the interior of the drum, wherein the brake rotor can project towards the inside of the drum and be connected to the transmission element, for example the ring gear, at the end portion of the adjacent planetary transmission, while the brake stator of the free fall brake can be arranged or project towards the outside or the end face of the drum in order to be supported in a rotationally fixed manner, for example on the bearing block of the cable winch.

The free fall brake can, for example, be configured as a multi-disc brake, wherein discs extending essentially transversely to the axis of rotation of the drum can be provided and can engage with one another, wherein the discs can be alternately attached to the brake rotor and to the brake stator. Advantageously, the brake discs can be arranged or accommodated completely in the interior of the drum, wherein a brake actuator for actuating or pressing the discs against each other may also be arranged in the interior of the drum. In the latter case, essentially only a part of the brake actuator protrudes from the drum in order to be supported on the bearing block of the cable winch. If necessary, however, the bearing block can also have a support stub protruding into the drum, to which the free fall brake can be attached.

Irrespective of the specific configuration of the free fall brake as a multi-disc brake or its arrangement in the interior of the drum, the brake rotor of the free fall brake can be coupled to the planetary transmission in such a manner that the brake rotor rotates at a rotational speed that is lower than the rotational speed of the winch drive but higher than the rotational speed of the drum. In particular, the brake rotor can rotate at the speed of the transmission element of the intermediate stage of the planetary transmission to which the brake rotor is connected in a rotationally fixed manner.

The connection of the output stage of the planetary transmission to the cable drum can be accomplished in different ways.

In order to be able to introduce the greatest possible torque into the drum, in an advantageous further development of the invention, the planet carrier of the output stage of the planetary transmission can be coupled to the drum in a rotationally fixed manner. In particular, if the planetary transmission is configured in such a way that the web shaft is the summation shaft, this allows the greatest torque to be introduced into the cable drum. The differential shaft, i.e., the inner wheel, transmits the reaction torque via the winch frame. This allows the greatest torque to be transmitted directly via the cable drum to the load to be moved.

In an alternative further development of the invention, however, the output stage of the planetary transmission can also be connected to the drum in a rotationally fixed manner via the ring gear thereof, so that the ring gear of the output stage transmits the torque to the drum. In this case, the planet carrier of the output stage can be arranged upright, in particular supported in a rotationally fixed manner on the bearing block of the cable winch, preferably together with the ring gear of the drive stage. This not only makes it possible to achieve a particularly simple and compact connection of the drum to the planetary transmission, as the ring gear of the output stage is located directly on or very close to the inner circumference of the drum, but also makes it easy to mount the planetary transmission itself. In this case, the firmly supported planet carrier of the output stage transmits the greatest torque to the winch frame, i.e., the greatest torque of the planetary transmission is transmitted via the bearing block or the winch frame or a fixed element of the installation environment.

These and other objects, features and advantages of the present invention will become more apparent upon reading the following specification in conjunction with the accompanying drawing figures.

### BRIEF DESCRIPTION OF THE DRAWINGS

The invention is explained in more detail below with reference to a preferred embodiment and the corresponding drawings. The drawings show:

FIG. 1 is a longitudinal section through a free fall winch according to an advantageous embodiment of the invention, in which the free fall brake is connected to an intermediate stage of the planetary transmission and the cable drum is mounted on the ring gear of the output stage of the planetary transmission in a rotationally fixed manner.

FIG. 2 is a longitudinal section through a free fall winch according to a further advantageous embodiment of the invention, in which the free fall brake is also connected to an intermediate stage of the planetary transmission, but in contrast to FIG. 1, the cable drum is attached to the planet carrier of the output stage in a rotationally fixed manner.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

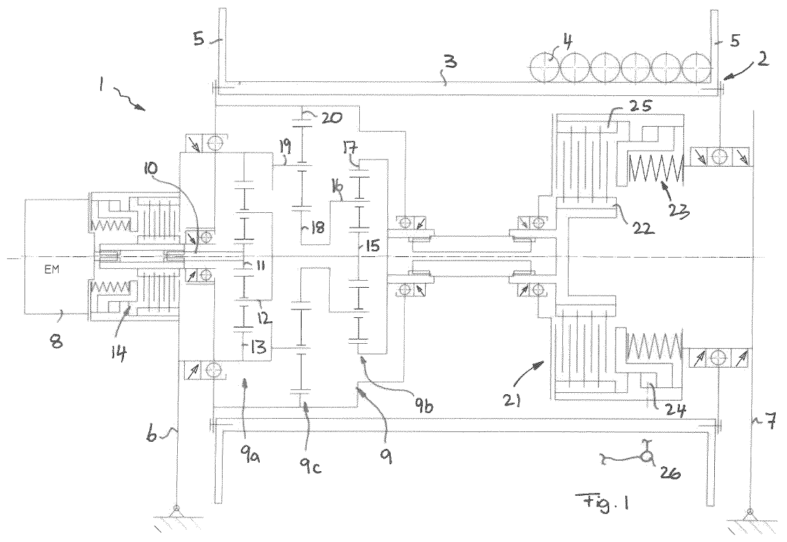

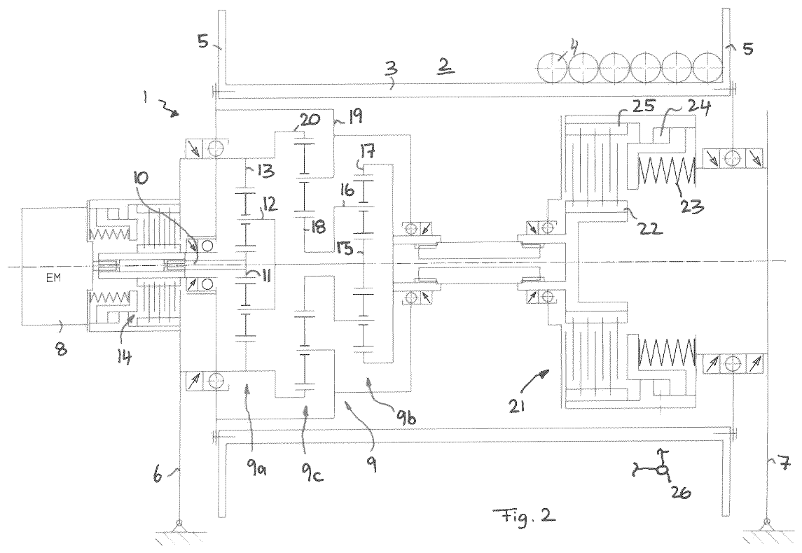

As the figures show, the free fall winch 1 comprises a drum 2 which has an approximately cylindrical drum shell 3 onto which a cable 4 can be wound. For this purpose, the drum shell 3 can comprise a cable groove on its outer side in order to enable controlled winding of the cable 4 and can be edged axially at the ends with flanged pulleys 5, see FIG. 1 and FIG. 2.

The drum 2 is rotatably mounted parallel to the longitudinal axis of the cylindrical drum shell 3. For this purpose, a pair of bearing plates 6 and 7 can be provided, on which the drum 2 is rotatably mounted, for example by roller and/or plain bearings. The bearing plates 6 and 7 themselves are mounted on a base structure on which the cable winch is to be used, for example on the superstructure of a cable excavator.

The cable winch further comprises a winch drive 8, for example in the form of an electric motor or a hydraulic motor, which can be arranged on one side of the drum 2, for example outside the bearing plate 6 provided there, and can be mounted in a fixed position, for example supported on the bearing plate 6.

The winch drive 8 drives the drum 2 via a multistage planetary transmission 9 in a rotational manner, wherein the planetary transmission 9 is multistage and can, for example, comprise three planetary stages 9a, 9b and 9c, cf. FIG. 1 and FIG. 2.

The planetary transmission 9 can be accommodated in the interior of the drum shell 3, so that the winch drive 8 and the predominant part of the planetary transmission 9 can extend on opposite sides of the bearing plate 6. A transmission input shaft 10 or a rotational transmission input element or, conversely, the output shaft of the winch drive 8 can extend through the bearing plate 6 in order to be able to transmit the rotational drive movement of the winch drive 8 through the bearing plate 6 to the internal planetary transmission 9.

For example, the winch drive 8 can drive a sun gear 11 of the first planetary stage, i.e., the drive stage of the planetary transmission 9, the planet carrier 12 of which can be coupled to the sun gear of the next or second planetary stage 9b.

The ring gear 13 of the first planet stage 9a can advantageously be supported in a rotationally fixed manner on the bearing plate 6 or another upright carrier part of the installation environment, although conversely it would also be possible to couple the ring gear 13 to the next planet stage and support the planet carrier 12 upright. However, the design option shown in the figures with rotationally drivable planet carrier 12 and upright supported ring gear 13 allows a high torque yield with a simple design and convenient assembly.

In order to be able to hold the cable winch in place under load during operation, a service brake 14 is provided, which can be configured as a multi-disc brake, for example, and can be locked independently of this by a pretensioning device, for example in the form of a spring device, and can be released by a pressure actuator or an electric actuator.

Regardless of the specific configuration, the service brake 14 can act on the winch drive 8 and/or be arranged between the winch drive 8 and the planetary transmission 9. Advantageously, the service brake 14 can be arranged on the side of the bearing plate 6 facing away from the planetary transmission 9, in particular coaxially to the output shaft of the winch drive 8. For example, the service brake 14 can act on the transmission input shaft 10 and/or the output shaft of the winch drive 8 in order to be able to release a load in a braked manner, or hold or block it in order to be able to hold a load at a certain height.

As the figures show, the output element of the first planetary stage 9a, which can be its planet carrier 12, can drive the sun gear 15 of the second planetary stage 9b or be coupled thereto in a rotationally fixed manner. The output element of the second planetary stage 9b can advantageously be its planet carrier 16, which in turn can drive the sun gear 18 of the third planetary stage 9b, cf. FIG. 1 and FIG. 2. The third planetary stage 9c can thereby form the output stage of the planetary transmission 9.

As the figures show, the output stage 9c of the planetary transmission 9 is advantageously arranged axially between the drive stage 9a and the intermediate stage 9b. The drive stage 9a and the intermediate stage 9b can be arranged at the axial end portions of the planetary transmission 9, wherein the drive stage 9a can be arranged on the side facing the winch drive 8 or the bearing plate 6, cf. FIG. 1 and FIG. 2, while the intermediate stage 9b can face the other axial end portion of the drum 2 or a free fall brake 21 accommodated therein.

As shown in FIGS. 1 and 2, the third planetary or output stage 9c of the planetary transmission 9 with its ring gear 20 as output element, cf. FIG. 1, or with its planet carrier 19 as output element, cf. FIG. 2, can be connected to the drum 2 in a rotationally fixed manner in order to drive the drum 2 rotationally. The connection of the ring gear 20 to the drum 2 results in a space-saving design with simple assembly, as the ring gear 20 is located close to the inside of the drum shell 3, as shown in FIG. 1. In this case, the planet carrier 19 of the output stage 9c can be mounted upright, for example supported on the bearing plate 6 together with the ring gear 13 of the first planet stage 9a.

On the other hand, a maximum torque can be transmitted to the drum 2 by using the planet carrier 19 as the output element of the third planetary stage 9c, wherein, in the case of connection of the planet carrier 19 to the drum 2 in a rotationally fixed manner, the ring gear 20 of the output stage 9c can be mounted upright, for example supported on the bearing plate 6 together with the ring gear 13 of the first planetary stage 9a, cf. FIG. 2.

Overall, the planetary transmission 9 with its several planetary stages 9a, 9b and 9c can be accommodated in an overall pot-shaped housing, which can be positioned inside the drum shell 2, cf. FIG. 1 and FIG. 2.

The aforementioned free fall brake 21 is advantageously connected to the intermediate stage 9b of the planetary transmission 9. As shown in FIGS. 1 and 2, the brake rotor 22 of the free fall brake 21 can in particular be coupled in a rotationally fixed manner to the ring gear 17 of the second planetary stage 9b, so that the brake rotor 22 rotates in winch operation at the speed of the ring gear 17 of the planetary stage 9.

The free fall brake 21 can, for example, be configured as a multi-disk brake, wherein a pretensioning device, for example in the form of a spring device for pretensioning the free fall brake 21 into the braking configuration, can be provided independently of this. An air release or release device 24, which can overcome the pre-tension of the pre-tensioning device 23 and separate the plates, can for example have a pressure medium cylinder or another actuator which counteracts the pre-tensioning device 23.

As shown in the figures, the free fall brake 21 can rotationally release or stationarily stop the transmission element of the intermediate stage 9b, which is connected to the brake rotor 22 in a rotationally fixed manner. For this purpose, the free fall brake 21 with its brake stator 25 can be supported in a rotationally fixed manner on the bearing plate 7, which is provided on the side of the drum 2 opposite the winch drive 8, or can be mounted in a rotationally fixed manner on another support part of the installation environment of the free fall winch 1. For example, the brake stator 25 can form a sleeve-or pot-shaped brake housing, which can be mounted in a fixed manner on the bearing plate 7 and at the same time can serve as a support for the brake rotor 22 and/or the drum 2, which can be seated rotatably on the housing-like brake stator by means of bearings.

In normal winch operation, for example to lift a load, the free-fall brake is closed so that the ring gear 17 of the intermediate stage 9b comes to a standstill. Conversely, the service brake 14 is released so that the winch drive 8 can drive the drive stage 9a via the sun gear 11, which then drives the drum 2 in a correspondingly rotational manner via the intermediate stage 9b and the output stage 9c.

For free fall operation, a control device 26 actuates the service brake 14, while on the other hand the free fall brake 21 is released. This brings the first planet stage 9a to a standstill, while the sun gear 15 of the intermediate stage 9b is also brought to a standstill by the rotationally fixed coupling with the planet carrier 12 of the drive stage 9a. The drum 2 can rotate in free fall, wherein the rotational movement of the drum 2 is introduced via the output stage 9c only into the intermediate stage 9b, more precisely its planet carrier 16 and its ring gear 17, and is transmitted from the ring gear 17 of the intermediate stage 9b to the brake rotor 22. Since the entire first planetary stage 9a and also the sun gear 15 of the second stage 9b do not rotate, the inertial mass is significantly reduced, which leads to very agile free-fall behavior with light-footed acceleration.

If, at the end of the free-fall process, for example when the cable excavator dragline hits the surface, the rotation of the drum 2 is to be stopped, the control device 26 causes the engagement or braking of the engagement brake 21, whereby the ring gear 17 of the intermediate stage 9b and thus the entire rotation of the drum 2 is stopped or braked. Due to the reduced inertial masses, which have moved along in free fall, the braking energy required is reduced and rapid braking of the drum can also be achieved.

As can be seen from the previous description, the free fall winch is characterized in particular by the following advantages:
fewer rotating components during a free fall operation
reduction of inertial masses
the free fall brake has to absorb less braking energy
therefore, faster braking and acceleration during a free fall operation
smaller brake dimensions without thermal overload
the entire system becomes more dynamic
less splash losses due to non-rotating planetary stage during a free fall operation
therefore, additionally reduced heat generation.

Particularly in case of cable excavators there are additionally obtained the following advantages:
more energy for soil compaction with the same drop height of the mass
in dragline operation, the dragline can be ejected further because the inertial masses in the cable drum are lower.

The following advantage can be added when using a slotted gripper:
the gripper experiences more energy when hitting the rock at the same drop height, which makes chiseling from low drop heights for loosening hard rock particularly efficient.

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A free fall winch comprising a drum rotatable by a winch drive via a multistage planetary transmission, wherein a first planetary stage of the multistage planetary transmission is a drive stage connected to the winch drive on an input side and can be braked by a service brake, and a third planetary stage of the multistage planetary transmission is an output stage connected to the drum on an output side, wherein a free fall brake is provided configured to brake the drum during a free fall operation and is connected to the multistage planetary transmission by means of a brake rotor, wherein the brake rotor of the free fall brake is rotationally fixed to a transmission element of the output stage or an optionally provided second planetary stage of the multistage planetary transmission being an intermediate stage, and wherein at least the drive stage is stopped during the free fall operation of the service brake.

2. The free fall winch according to claim 1, wherein the multistage planetary transmission is configured to be at least three-stages and the brake rotor of the free fall brake is connected to the intermediate stage.

3. The free fall winch according to claim 2, wherein the brake rotor is connected to the intermediate stage directly connected to the drive stage.

4. The free fall winch according to claim 1, wherein the brake rotor is rotationally fixed to a ring gear of the intermediate stage.

5. The free fall winch according to claim 1, wherein at least one of:
the output stage is arranged between the drive stage and the intermediate stage, as viewed in an axial direction of the drum; or
the drive stage and the intermediate stage are arranged at opposite axial end portions of the multistage planetary transmission.

6. The free fall winch according to claim 1, wherein the connection of the winch drive to the multistage planetary transmission and the free fall brake are arranged on opposite sides of the multistage planetary transmission.

7. The free fall winch according to claim 1, wherein the drive stage comprises a ring gear which, in addition to a sun gear that can be stopped by the service brake, is supported perpendicularly and in a rotationally fixed manner or can be stopped by an additional brake.

8. The free fall winch according to claim 1, wherein a sun gear of the drive stage is connected to the winch drive and a ring gear of the drive stage is supported in a rotationally fixed manner on a first bearing plate of the free fall winch or stationarily and in a rotationally fixed manner on a stationary carrier element of an installation environment, while a planet carrier of the drive stage is connected to the intermediate stage.

9. The free fall winch according to claim 8, wherein the planet carrier of the drive stage is coupled to a sun gear of the intermediate stage in a rotationally fixed manner, and wherein a ring gear of the intermediate stage is coupled to the brake rotor of the free fall brake in a rotationally fixed manner.

10. The free fall winch according to claim 1, wherein the output stage is connected to the drum in a rotationally fixed manner by means of a ring gear thereof the output stage as an output element and is supported by means of a planet carrier thereof the output stage stationarily and in a rotationally fixed manner on a first bearing plate of the free fall winch or on a stationary planet carrier of an installation environment.

11. The free fall winch according to claim 1, wherein the output stage is connected to the drum in a rotationally fixed manner by means of a planet carrier thereof the output stage as output element, and wherein a ring gear of the output stage is supported stationarily and in a rotationally fixed manner on a first bearing plate of the free fall winch or on a stationary planet carrier of an installation environment.

12. The free fall winch according to claim 1, wherein the multistage planetary transmission and/or the free fall brake are accommodated substantially completely within an interior of the drum.

13. The free fall winch according to claim 1, wherein the free fall brake is supported on a bearing plate of the free fall winch or a stationary carrier element of an installation environment by means of a brake stator in a rotationally fixed manner and blocks the a ring gear of the intermediate stage, in the braked state relative to the bearing plate or the stationary planet carrier of the installation environment.

14. The free fall winch according to claim 1, wherein the service brake is configured for braking the drive stage is arranged between the winch drive and the multistage planetary transmission.

15. The free fall winch according to claim 1, wherein the service brake acts on a transmission input shaft of the multistage planetary transmission or an output shaft of the winch drive.

16. The free fall winch according to claim 14, wherein the service brake is seated on an outer side of the first bearing plate of the free fall winch.

17. The free fall winch according to claim 15, wherein the service brake acts on the transmission input shaft of the multistage planetary transmission or an output shaft of the winch drive.
